(19) United States
(12) Patent Application Publication
(10) Pub. No.: US 2012/0267495 A1
(43) Pub. Date: Oct. 25, 2012

(54) SYSTEM AND METHOD FOR HOLDING AN OPTICAL ROD

(75) Inventors: Robert Olma, Schaumburg, IL (US); Kenneth Rietveld, Mundelein, IL (US); Jamie Swayne, Lake Zurich, IL (US)

(73) Assignee: EXCELITAS TECHNOLOGIES LED SOLUTIONS, INC., Wheeling, IL (US)

(21) Appl. No.: 13/426,448

(22) Filed: Mar. 21, 2012

Related U.S. Application Data
(60) Provisional application No. 61/454,907, filed on Mar. 21, 2011.

(51) Int. Cl. G02B 7/00

(52) U.S. Cl. 248/251

(57) ABSTRACT

A system for holding an optical rod, contains an optical mount having a hole traversing throughout a body of the optical mount, wherein the optical mount is a c-shaped collar clamp. The system also contains an optical rod having a circumferential area and a split sleeve encompassing the optical rod circumferential area for at least a portion of the axial length of the optical rod. The split sleeve and optical rod are inserted within the optical mount hole, and the split sleeve contains an inner surface and an outer surface, where material of the split sleeve does not conform intimately with the optical rod so as to maintain total internal reflection conditions.

### CROSS-REFERENCE TO RELATED APPLICATION

This application claims priority to copending U.S. Provisional Application entitled, “OPTICAL ROD HOLDER CLAMP,” having Ser. No. 61/454,907, filed Mar. 21, 2011, which is entirely incorporated herein by reference.

### FIELD OF THE INVENTION

The present invention is generally related to holders, and more particularly is related to an optical rod holder and method.

### BACKGROUND OF THE INVENTION

The existence of collars, shaft couplings, split collars, and the like, which are removably installed onto rotating shafts, is well known. The collars hold various rotary components such as pulleys, gears, and bearings in an axial position on a shaft. This concept of the “clamp collar” can be utilized on many different applications not only related to machines or their components, but also optical applications.

In U.S. Pat. No. 5,061,026, an optical glass rod is constrained in its housing by a set screw. This configuration can pose a problem in safely holding the glass rod and may cause the glass rod to crack. This holding method attempts to minimize optical contact between the optical glass rod and the housing.

U.S. Pat. No. 3,946,467, also attempts to hold a plastic coated optical fiber at minute contact areas along its axial length. In order for this method to securely hold the optical fiber along its longitudinal axis, it needs to be long. Also, the invention of U.S. Pat. No. 3,946,467 addresses the sensitivity of the clamping force needed to safely hold the optical fiber.

Unfortunately, examples of which are described above, prior art methods of holding an optical fiber fall short of providing a reliable holding method that will result is securing the optical fiber without increased risk of harming the optical fiber or having a detrimental effect on light transmission efficiency. Thus, a heretofore unaddressed need exists in the industry to address the aforementioned deficiencies and inadequacies.

### SUMMARY OF THE INVENTION

Embodiments of the present invention provide a system for holding an optical rod. Briefly described, in architecture, one embodiment of the system, among others, can be implemented as follows. The system contains an optical mount having a hole traversing throughout a body of the optical mount, wherein the optical mount is a c-shaped collar clamp. The system also contains an optical rod having a circumferential area and a split sleeve encompassing the optical rod circumferential area for at least a portion of the axial length of the optical rod. The split sleeve and optical rod are inserted within the optical mount hole, and the split sleeve contains an inner surface and an outer surface, where material of the split sleeve does not conform intimately with the optical rod so as to maintain total internal reflection conditions.

In accordance with a second exemplary embodiment of the invention, the system for holding an optical rod contains an optical mount having a hole traversing throughout a body of the optical mount, wherein an inner surface of the hole contains at least one radial protrusion, and wherein the optical mount is a c-shaped collar clamp. The system also contains an optical rod having a circumferential area, wherein the optical mount makes minimal direct contact with the optical rod so as to minimize light transmission losses associated with light traversing the optical rod.

In accordance with a third exemplary embodiment of the invention, the system for holding an optical rod, contains an optical mount having a hole traversing throughout a body of the optical mount, wherein an inner surface of the hole contains multiple inner diameter protrusions resembling an extruded shape spanning an axial length of the inner surface of the hole, and wherein the optical mount is a c-shaped collar clamp. The system also contains an optical rod having a circumferential area, wherein the optical mount makes minimal direct contact with the optical rod so as to minimize light transmission losses associated with light traversing the optical rod.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a prior art schematic diagram illustrating Snell's law.

FIG. 2 is a prior art schematic diagram illustrating total internal reflection.

FIG. 3 is a prior art schematic diagram illustrating use of a cladding material as a buffer.

FIG. 4 is an exploded view of the present invention.

FIG. 5 is a top perspective of the present invention showing clamping screws.

FIG. 6 is a front sectional perspective of the present invention showing a clamping screw and corresponding nut.

FIG. 7 is the bottom perspective of the present invention showing nuts corresponding to the clamping screw of FIG. 6.

FIG. 8 is a right end perspective view of the present invention.

FIG. 9 is a magnified detail of FIG. 6.

FIG. 10 is a right-end sectional perspective of the present invention.

FIG. 11 is a magnified detail of present invention illustrated by FIG. 10.

FIG. 12 is a front perspective of the present invention illustrating section lines.

FIG. 13 is a magnified view of FIG. 11 showing light beam behavior without a split sleeve.

FIG. 14 is a magnified view of FIG. 11 showing a light beam behavior with a split sleeve.

FIG. 15 is a front perspective of the present invention showing an alternative method of holding an optical rod in accordance with a second exemplary embodiment of the invention.

FIG. 16 is a magnified detail of FIG. 15.

FIG. 17 is a right-end sectional perspective of the present invention in accordance with the second exemplary embodiment of the invention, as illustrated by FIG. 15.

FIG. 18 is a front perspective of the present invention showing an alternative method of holding the optical rod in accordance with a third exemplary embodiment of the invention.

FIG. 19 is a magnified detail of FIG. 20.

FIG. 20 is a right-end sectional perspective of the present invention in accordance with the third exemplary embodiment of the invention, as illustrated by FIG. 18.

### DETAILED DESCRIPTION

The present invention is provided to hold an optical fiber or rod with greater strength and without risking fracturing fragile material of the optical fiber or rod. It is desired to hold such an optical component throughout its axial length that can vary, in order to protect its fragile composition and not hinder optical performance. This requires a derived form, as is provided by the C-shaped clamp collar of the present invention. By making use of this approach, the present invention provides for accurately, rigidly, and safely holding the optical rod in close proximity of a high or low output light source. By choosing the appropriate materials, in the present invention light is guided axially and transmitted by minimizing the loss of total internal reflection in the optical rod, when introducing a light source at a given end along its axis.

The present invention utilizes the concept of a C-shaped clamp collar to rigidly hold a cylindrical optical rod. It should be noted that while the following refers to an optical rod, one having ordinary skill in the art would appreciate that the terms optical fiber and optical rod may be used interchangeably. The purpose of the optical rod is to act as a light guide to transmit light from one end to another. This light guide functions by the optical principle of total internal reflection (“TIR”) according to Snell's Law, as shown by equation 1.

N₁ sin Θ₁=N₂ sin Θ₂ (Eq. 1)

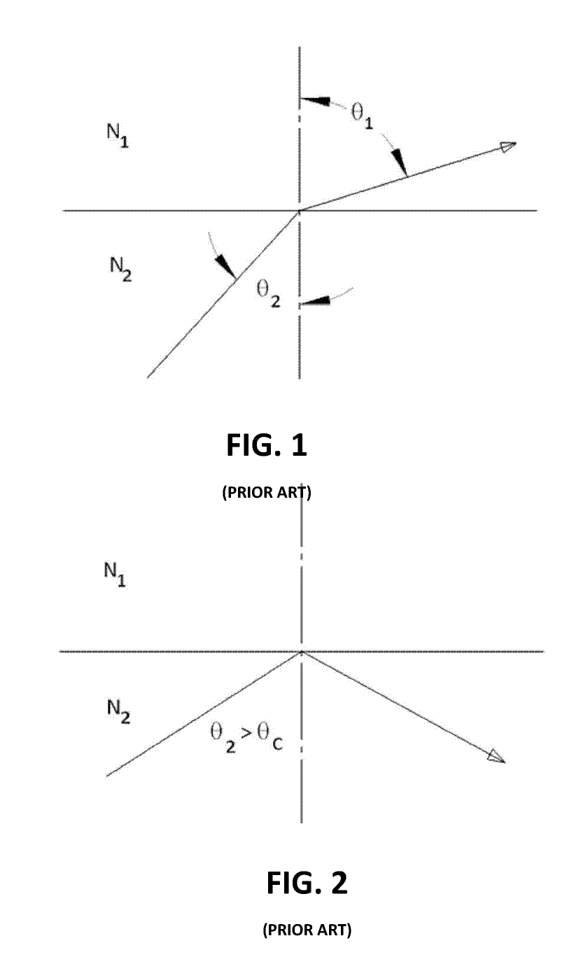

FIG. 1 is a schematic diagram better illustrating the principles of Snell's Law. In FIG. 1 N₁ and N₂ are the indices of refraction of two materials on either side of a material transition interface and Θ₁ and Θ₂ are the angles with respect to the normal to the interface. In the case where N₂>N₁, Θ₁ will approach 90° as Θ₂ increases. When Θ₁ reaches 90°, Θ₂ is said to be at the critical angle or Θ_{C}. At Θ_{C} and all values of Θ₂ higher than Θ_{C}, all the incident light on the interface is reflected. This is referred to as Total Internal Reflection (TIR), as illustrated by the schematic diagram of FIG. 2.

Referring to FIG. 2, the greater the value for Θ_{C}, the greater the amount of light that can be transferred by a light guide via TIR. One of the problems with using a C-shaped clamp to retain a light guide is that if the clamp material is soft and malleable, its surface will conform to the surface of the light guide resulting in an optical interface. Since any malleable clamping material will have an index of refraction greater than that of air, conforming to the surface of the light guide (optical rod) will cause the critical angle to decrease, resulting in light escaping the light guide, which would otherwise be conducted through the light guide. To address this problem a cladding material of lower index of refraction material could be used to act as a buffer between the light guide material and the clamp material.

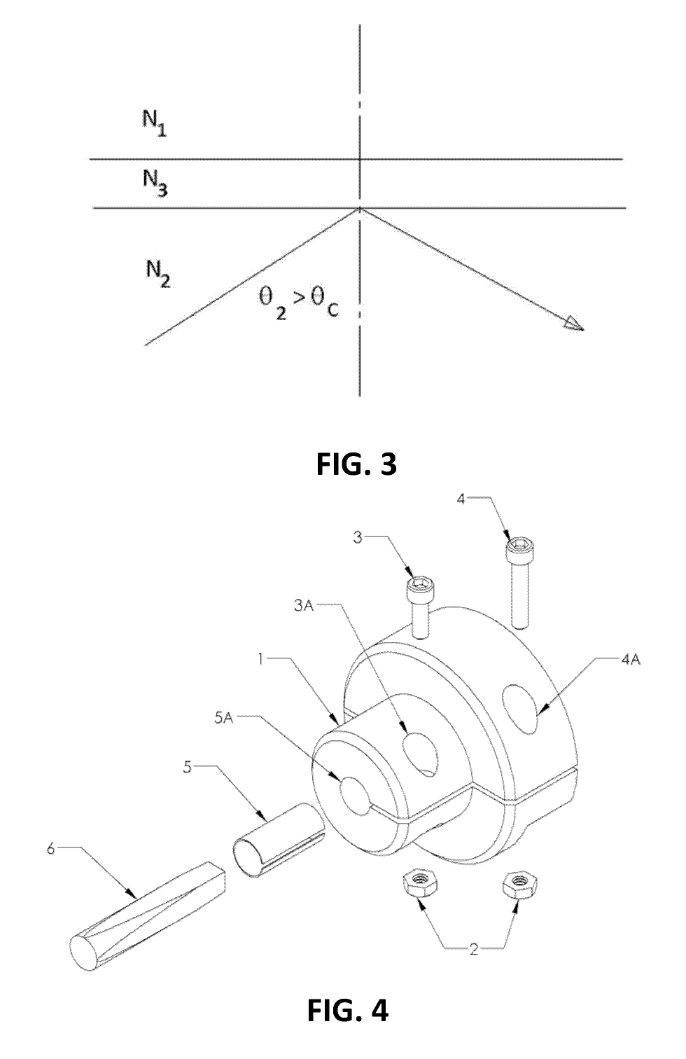

A cladding solution has limitations in that cladding material will have an index of refraction greater than that of air resulting in a reduced value for Θ_{C} and less light throughput. FIG. 3 is a schematic diagram illustrating use of cladding material N₃ as a buffer. The present invention remedies such a problem with a flexible split sleeve that encompasses the optical rod circumferential area for a portion or the entirety of its axial length. In accordance with the present invention, chosen split sleeve material is such that it does not conform to this critical surface to the degree that optical contact is established, and thus ensures efficient light transmission.

The following further describes different embodiments of the present invention. It should be noted that the present invention and its components may take on many different forms, shapes, and colors. The present description merely provides exemplary embodiments of such forms, shapes, and colors, however, the present invention is not intended to be limited to this description solely.

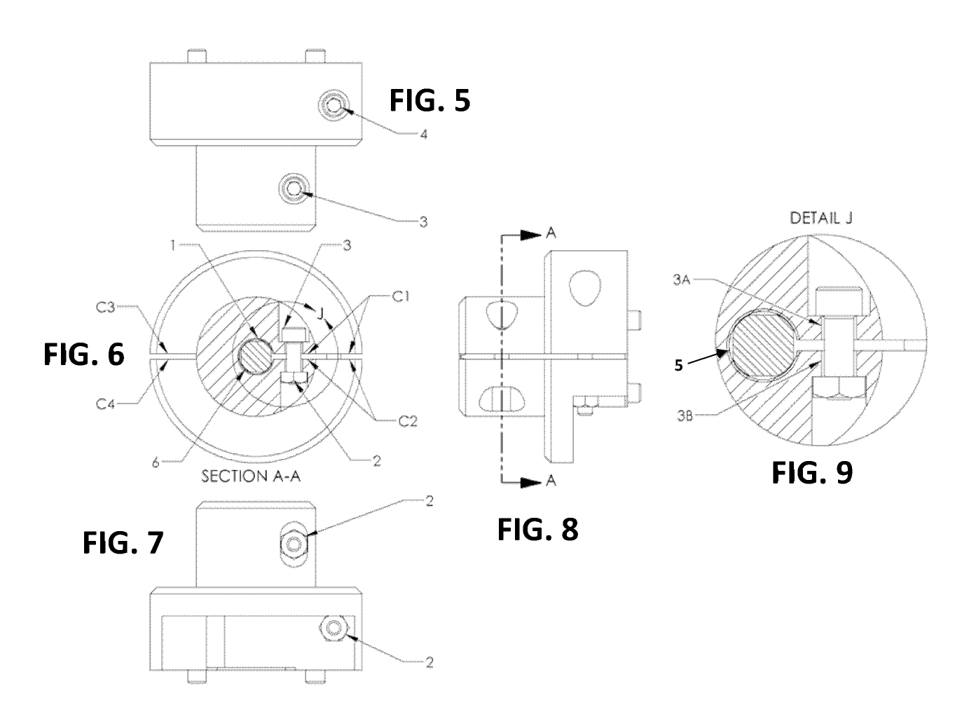

FIG. 4 is a schematic diagram illustrating a “C-shaped collar clamp”, or optical mount 1, in accordance with the present invention. A split sleeve 5 is inserted into a hole 5A of the optical mount 1, wherein the hole traverses throughout the body of the optical mount 1. The optical rod 6 is inserted into the split sleeve 5 and optical mount 1. Two screws, namely, screw 3 and screw 4, are inserted through corresponding counter bored thru-holes 3A, 4A of the optical mount 1. Two nuts 2 are installed on the opposing sides of the screws 3, 4. FIG. 6 is a front sectional perspective of the present invention showing the clamping screw 3 and corresponding nut 2. In addition, FIG. 9 provides magnified detail of FIG. 6.

Referring to FIG. 4 through FIG. 9, screw 3 and screw 4 are then tightened with the two corresponding nuts 2 to slightly deform the optical mount 1 such that surface C1 and surface C2 of the optical mount 1 are moved closer together as illustrated in FIG. 3. As shown by FIG. 6, surfaces C1 and C2 are internal opposed ends of the optical mount 1. The deformation of the optical mount 1 then exerts radial clamping forces onto the split sleeve 5. The split sleeve 5 congruently deforms to exert equal radial clamping forces onto the optical rod 6.

The present invention not only can take on many forms, shapes and colors, but the materials chosen are not restricted to the ones disclosed in the present description. In accordance with the present invention, the optical mount 1 is made of a plastic material and non-dark in color. The external shape of the optical mount 1 is defined by surrounding components found in the product. The plastic material has been chosen for electrical and thermal insulation purposes. This minimizes light energy absorbed into the optical mount 1.

FIG. 6 and FIG. 9 display the split sleeve 5 residing in a counter-bore diameter that is equal to or slightly smaller than the outer diameter of the split sleeve 5. Referring to FIG. 6, the thru-hole 3A & 3B (thru-hole 4A & 4B are similar) found in FIG. 6 and FIG. 9 do not have to be thru-holes that exist through both the upper and lower halves of the split optical mount 1. Holes 3B & 4B can be threaded, although it is not a requirement for them to be threaded. The split sleeve 5 contains thin elastic metal material such as, but not limited to, steel. The length of the split sleeve 5 can span the entire length of the optical mount 1 in order not to expose the optical rod 6 surfaces to contact the material of the optical mount 1. The optical rod 6 is made from an optically transparent material whose index of refraction, when measured at the sodium D-line of 589 nm, is between 1.30 and 4.00.

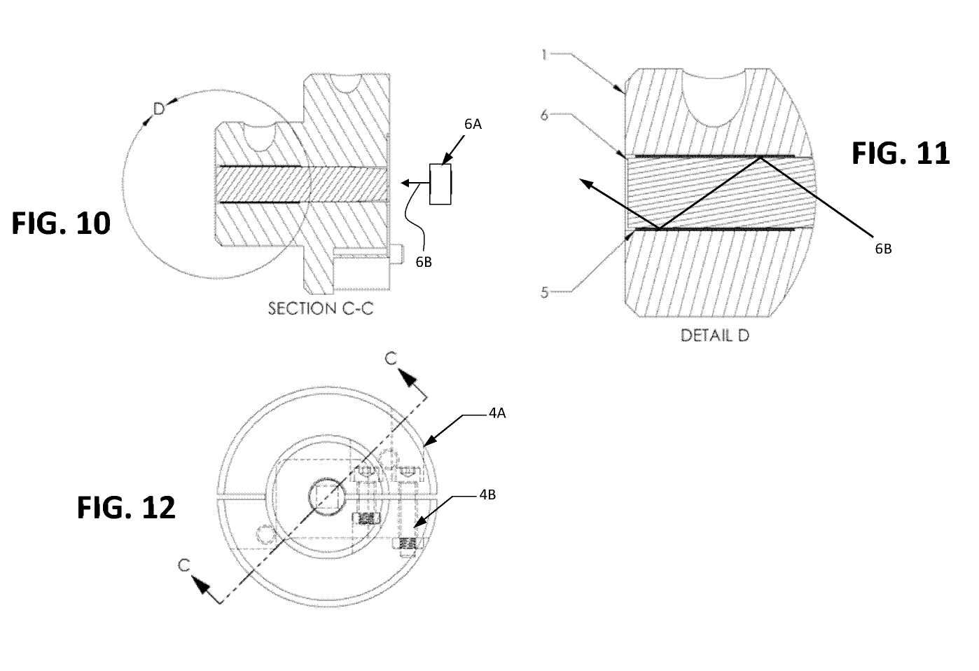

In accordance with the present embodiment of the invention, the optical rod 6 has a square end conforming to the shape of the light source 6A, as shown in FIG. 10, and over remaining length lofts to a circular shape to match the shape of the mating light receiver. The optical rod 6 can take on various modified cylindrical geometries, such as having multiple array(s) of facets spanning a portion or the entire axial length of the optical rod 6.

FIG. 10 illustrates the cross-sectional view of FIG. 12 and also shows a light source 6A and its proximity to the optical rod 6. As shown by FIG. 10, a representative light beam 6B radiates from the light source 6A. In FIG. 11, the light beam 6B enters the optical rod 6 and is transmitted through by being internally reflected along the axial length of the optical rod 6. The light beam 6B will travel most efficiently where it will not be exposed to an area where the optical rod 6 has “conformed” contact to the optical mount 1 material. To minimize or prevent this, the split sleeve 5, not only holds the optical rod 6 around the circumferential surfaces of the optical rod 6, but the split sleeve 5 also is made of a material that does not conform intimately with the optical rod 6 so as to maintain TIR conditions, as exemplified in FIG. 14.

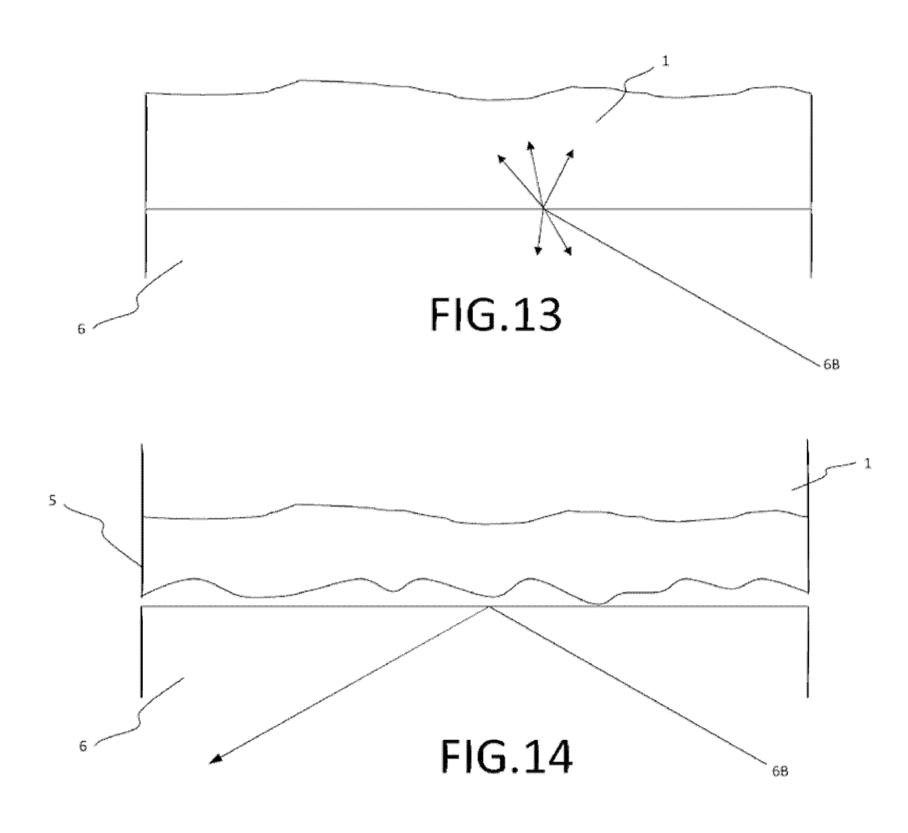

FIG. 13 illustrates a magnified view on a microscopic level of an arrangement wherein the optical rod 6 is secured within the optical mount 1 without the split sleeve 5. In this case, the softer plastic material of the optical mount 1 tends to substantially conform to the outer circumferential shape of the optical rod 6. Because the index of refraction for the optical mount 1 is far greater than the index of refraction of air, the light beam 6B couples into the optical mount 1 and is absorbed therein, leading to unacceptable losses.

FIG. 14 is a view similar to FIG. 13, but wherein the split sleeve 5 is interposed between the optical rod 6 and the optical mount 1. Since the split sleeve 5 is formed of a more rigid material, (e.g., steel), it will be less deformable than the material of the optical mount 1. The presence of microscopic roughness on the inner surface of the split sleeve 5 will create an air gap between the sleeve and the outer surface of the optical rod 6 with only the high points of the split sleeve 5 being in contact with the optical rod 6. Since the index of refraction of the air in the gap is less than the index of refraction of the optical rod 6, total internal reflection within the optical rod 6 is maintained, minimizing or preventing any light loss during transmission of the light beam 6B through the optical rod 6.

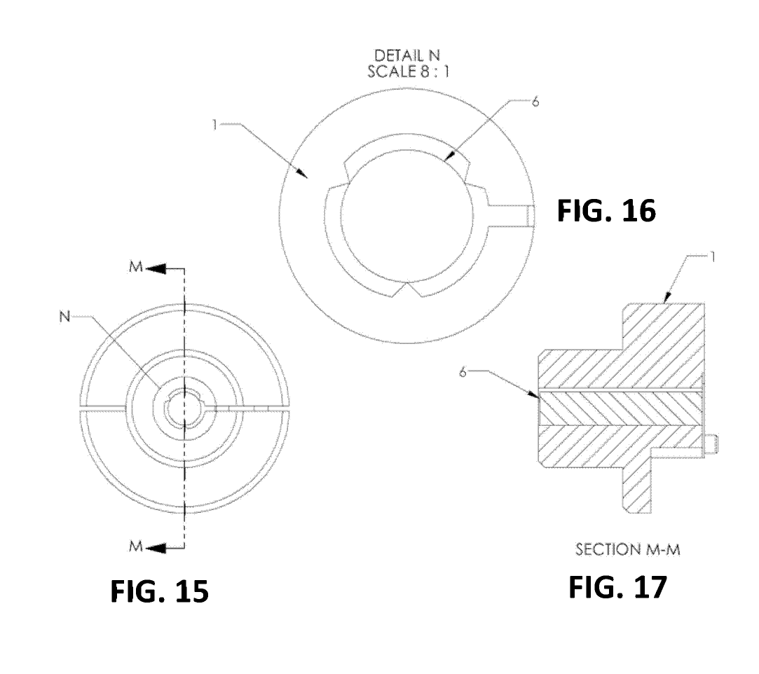

FIG. 15 illustrates an alternative configuration of the present invention for holding the optical rod 6 in accordance with a second exemplary embodiment of the invention. In accordance with this exemplary embodiment, there are multiple inner diameter protrusions resembling extruded triangles spanning the axial length of the inner diameter of the optical mount 1 shown in FIG. 16. In addition, the optical rod 6 is a cylinder, as illustrated in FIG. 17. These protrusions, also known in the industry as splines, can be in other shapes and sizes. This method of holding the optical rod 6 does not utilize a split sleeve 5. Instead, the optical mount 1 makes as minimal direct contact with the optical rod 6 as possible. The light transmission losses are minimal.

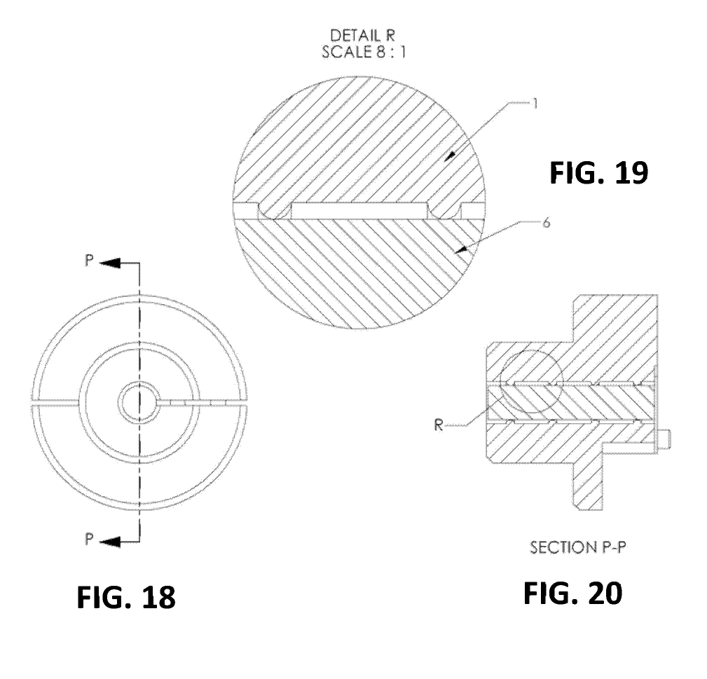

FIG. 18 illustrates another alternative configuration of the present invention for holding the optical rod 6 in accordance with a third exemplary embodiment of the invention. In accordance with this exemplary embodiment, there are multiple radial protrusions on the inner diameter surface, resembling a semi-circular profile that is revolved around the centerline axis of the optical mount 1 at various points along its axial length as shown in FIGS. 19 and 20. Also, the optical rod 6 is a cylinder. These protrusion profiles can be in other shapes and sizes. This method of holding the optical rod 6 does not utilize a split sleeve 5. Instead, the optical mount 1 makes as minimal direct contact with the optical rod 6 as possible. The light transmission losses are minimal based on the theory presented.

While the present description provides multiple embodiments and configurations, it should be noted that the present invention is not limited to these embodiments and configurations. Instead, other embodiments and configurations may be provided, as an example, by combining elements of different embodiments, such as combining the square end configuration optical rod 6 with protrusions of the second exemplary embodiment or a form of radial protrusion of the third exemplary embodiment.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A system for holding an optical rod, comprising:
an optical mount having a hole traversing throughout a body of the optical mount, wherein the optical mount is a c-shaped collar clamp;
an optical rod having a circumferential area; and
a split sleeve encompassing the optical rod circumferential area for at least a portion of the axial length of the optical rod,
wherein the split sleeve and optical rod are inserted within the optical mount hole, and
wherein the split sleeve contains an inner surface and an outer surface, where material of the split sleeve does not conform intimately with the optical rod so as to maintain total internal reflection conditions.

2. The system of claim 1, wherein a length of the split sleeve spans the entire length of the optical mount in order not to expose an optical rod surfaces to contact the optical mount.

3. The system of claim 1, wherein the optical rod is made from an optically transparent material whose index of refraction, when measured at a sodium D-line of 589 nm, is between 1.30 and 4.00.

4. The system of claim 1, wherein the optical mount rigidly holds the optical rod within the hole.

5. The system of claim 1, wherein the optical rod has a square end.

6. The system of claim 1, wherein the split sleeve is made of steel.

7. The system of claim 1, wherein the optical mount is constructed of a plastic material having electrical and thermal insulating properties.

8. The system of claim 1, wherein the optical rod has at least one array of facets spanning at least a portion of the axial length of the optical rod.

9. A system for holding an optical rod, comprising:
an optical mount having a hole traversing throughout a body of the optical mount, wherein an inner surface of the hole contains at least one radial protrusion, wherein the optical mount is a c-shaped collar clamp; and
an optical rod having a circumferential area,
wherein the optical mount makes minimal direct contact with the optical rod so as to minimize light transmission losses associated with light traversing the optical rod.

10. The system of claim 9, wherein the optical rod is made from an optically transparent material whose index of refraction, when measured at a sodium D-line of 589 nm, is between 1.30 and 4.00.

11. The system of claim 9, wherein the optical mount rigidly holds the optical rod within the hole.

12. A system for holding an optical rod, comprising:
an optical mount having a hole traversing throughout a body of the optical mount, wherein an inner surface of the hole contains multiple inner diameter protrusions resembling an extruded shape spanning an axial length of the inner surface of the hole, wherein the optical mount is a c-shaped collar clamp; and
an optical rod having a circumferential area,
wherein the optical mount makes minimal direct contact with the optical rod so as to minimize light transmission losses associated with light traversing the optical rod.

13. The system of claim 12, wherein the optical rod is made from an optically transparent material whose index of refraction, when measured at a sodium D-line of 589 nm, is between 1.30 and 4.00.

14. The system of claim 12, wherein the extruded shape is in the shape of a triangle.
